(19) United States
(12) Patent Application Publication
(10) Pub. No.: US 2026/0170462 A1
(43) Pub. Date: Jun. 18, 2026

(54) ARTIFICIAL INTELLIGENCE (AI) DRIVEN CONFLICT DETECTION IN COLLABORATIVE CONTENT MANAGEMENT

(71) Applicant: Notion Labs, Inc., San Francisco, CA (US)

(72) Inventors: Varun Krishna Rau, San Francisco, CA (US); Anshul Aggarwal, San Francisco, CA (US)

(21) Appl. No.: 19/097,571

(22) Filed: Apr. 1, 2025

Related U.S. Application Data
(60) Provisional application No. 63/735,096, filed on Dec. 17, 2024.

(51) Int. Cl. G06Q 10/10; G06F 9/451

(52) U.S. Cl. CPC G06Q 10/103; G06F 9/451

(57) ABSTRACT

Disclosed herein are techniques for artificial intelligence (AI) driven conflict detection in collaborative content management. A computing platform having a block-based data structure can generate and display a graphical user interface (GUI) that can include a conflict check entry point. Upon detecting a user interaction with the entry point, the platform can determine and use a block identifier and/or additional contextual information to generate a set of questions regarding content of the block displayed at the GUI. The questions can be generated using intent assessment techniques. Using the generated questions, the platform can query cross-validation compute resources, generate or obtain cross-validation data items, and perform cross-validation of one or more items referenced by the block identifier. Cross-validation operations can be based on content, derived content, metadata, sampling, data schema definitions, other suitable techniques, and/or combinations thereof. The platform can raise alerts and/or facilitate automatic actions in response to cross-validation results.

### CROSS-REFERENCE TO RELATED APPLICATION(S)

This application claims the benefit of priority of U.S. Provisional Application No. 63/735,096 and filed on Dec. 17, 2024. The content of which is herein incorporated by reference in its entirety.

### BACKGROUND

Collaborative content management is an approach to content creation and publication where teams can utilize project management systems, third-party tools, and/or real-time communication platforms to create content, create project plans, assign tasks, track progress, and manage workflows efficiently. Additionally, the use of third-party systems such as chat applications (e.g., Slack, Microsoft Teams) can enable communication and feedback sharing among team members.

A collaborative content management ecosystem can facilitate the production, review, and approval of content, ensuring that stakeholders are informed and aligned throughout the content lifecycle. However, when different systems within a collaborative content management ecosystem have out-of-date data, this can result in hindered productivity and efficiency. For instance, if a project management system is not synchronized with a chat application, team members may receive outdated task assignments or feedback, causing confusion and miscommunication. Furthermore, if a content management system is not synchronized with other tools, this can result in version control issues, where multiple stakeholders are working on different versions of the same content. These inefficiencies can lead to wasted time, duplicated effort, and ultimately, a poor user experience.

### BRIEF DESCRIPTION OF THE DRAWINGS

Reference will now be made, by way of example, to the accompanying drawings which show example embodiments of the present application, and in which:

FIG. 1 is a block diagram illustrating a platform, which may be used to implement examples of the present disclosure.

FIG. 2 is a block diagram of a transformer neural network, which may be used in examples of the present disclosure.

FIG. 3 is a block diagram illustrating a hierarchical organization of pages in a workspace.

FIG. 4A is a block diagram illustrating an example process for automated, AI-driven conflict detection in collaborative content management.

FIG. 4B is a block diagram illustrating an example flow of electronic messages for automated, AI-driven conflict detection in collaborative content management.

FIG. 5 shows an example entry point for for automated, AI-driven conflict detection in collaborative content management.

FIG. 6 is a block diagram that illustrates an example of a computer system in which at least some operations described herein can be implemented.

The technologies described herein will become more apparent to those skilled in the art by studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present technology provides for artificial intelligence (AI) driven conflict detection in collaborative content management. In an example, AI-driven conflict detection in collaborative content management can include identifying inconsistent content across disparate data sources, such as determining, in an automated fashion, when something is out of date. Conventionally, verifiers face a challenge of having to maintain a potentially large number of pages, and the harder it is to review and verify pages, the fewer pages will ultimately be verified. Without verification, collaborators, readers, and other data consumers can struggle to assess if the content in pages, blocks, and/or teamspaces is accurate and up-to-date.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Block Data Model

The disclosed technology includes a block data model (“block model”). The blocks are dynamic units of information that can be transformed into other block types and move across workspaces. The block model allows users to customize how their information is moved, organized, and shared. Hence, blocks contain information but are not siloed.

Blocks are singular pieces that represent all units of information inside an editor. In one example, text, images, lists, a row in a database, etc., are all blocks in a workspace. The attributes of a block determine how that information is rendered and organized. Every block can have attributes including an identifier (ID), properties, and type. Each block is uniquely identifiable by its ID. The properties can include a data structure containing custom attributes about a specific block. An example of a property is “title,” which stores text content of block types such as paragraphs, lists, and the title of a page. More elaborate block types require additional or different properties, such as a page block in a database with user-defined properties. Every block can have a type, which defines how a block is displayed and how the block’s properties are interpreted.

A block has attributes that define its relationship with other blocks. For example, the attribute “content” is an array (or ordered set) of block IDs representing the content inside a block, such as nested bullet items in a bulleted list or the text inside a toggle. The attribute “parent” is the block ID of a block’s parent, which can be used for permissions. Blocks can be combined with other blocks to track progress and hold all project information in one place.

A block type is what specifies how the block is rendered in a user interface (UI), and the block’s properties and content are interpreted differently depending on that type. Changing the type of a block does not change the block’s properties or content—it only changes the type attribute. The information is thus rendered differently or even ignored if the property is not used by that block type. Decoupling property storage from block type allows for efficient transformation and changes to rendering logic and is useful for collaboration.

Blocks can be nested inside of other blocks (e.g., infinitely nested sub-pages inside of pages). The content attribute of a block stores the array of block IDs (or pointers) referencing those nested blocks. Each block defines the position and order in which its content blocks are rendered. This hierarchical relationship between blocks and their render children are referred to herein as a “render tree.” In one example, page blocks display their content in a new page, instead of rendering it indented in the current page. To see this content, a user would need to click into the new page.

In the block model, indentation is structural (e.g., reflects the structure of the render tree). In other words, when a user indents something, the user is manipulating relationships between blocks and their content, not just adding a style. For example, pressing Indent in a content block can add that block to the content of the nearest sibling block in the content tree.

Blocks can inherit permissions of blocks in which they are located (which are above them in the tree). Consider a page: to read its contents, a user must be able to read the blocks within that page. However, there are two reasons one cannot use the content array to build the permissions system. First, blocks are allowed to be referenced by multiple content arrays to simplify collaboration and a concurrency model. But because a block can be referenced in multiple places, it is ambiguous which block it would inherit permissions from. The second reason is mechanical. To implement permission checks for a block, one needs to look up the tree, getting that block’s ancestors all the way up to the root of the tree (which is the workspace). Trying to find this ancestor path by searching through all blocks’ content arrays is inefficient, especially on the client. Instead, the model uses an “upward pointer”—the parent attribute—for the permission system. The upward parent pointers and the downward content pointers mirror each other.

A block’s life starts on the client. When a user takes an action in the interface—typing in the editor, dragging blocks around a page—these changes are expressed as operations that create or update a single record. The “records” refer to persisted data, such as blocks, users, workspaces, etc. Because many actions usually change more than one record, operations are batched into transactions that are committed (or rejected) by the server as a group.

Creating and updating blocks can be performed by, for example, pressing Enter on a keyboard. First, the client defines all the initial attributes of the block, generating a new unique ID, setting the appropriate block type (to_do), and filling in the block’s properties (an empty title, and checked: [[“No”]]). The client builds operations to represent the creation of a new block with those attributes. New blocks are not created in isolation: blocks are also added to their parent’s content array, so they are in the correct position in the content tree. As such, the client also generates an operation to do so. All these individual change operations are grouped into a transaction. Then, the client applies the operations in the transaction to its local state. New block objects are created in memory and existing blocks are modified. In native apps, the model caches all records that are accessed locally in an LRU (least recently used) cache on top of SQLite or IndexedDB, referred to as RecordCache. When records are changed on a native app, the model also updates the local copies in RecordCache. The editor re-renders to draw the newly created block onto the display. At the same time, the transaction is saved into TransactionQueue, the part of the client responsible for sending all transactions to the model’s servers so that the data is persisted and shared with collaborators. TransactionQueue stores transactions safely in IndexedDB or SQLite (depending on the platform) until they are persisted by the server or rejected.

A block can be saved on a server to be shared with others. Usually, TransactionQueue sits empty, so the transaction to create the block is sent to the server in an application programming interface (API) request. In one example, the transaction data is serialized to JSON and posted to the /saveTransactions API endpoint. SaveTransactions gets the data into source-of-truth databases, which store all block data as well as other kinds of persisted records. Once the request reaches the API server, all the blocks and parents involved in the transaction are loaded. This gives a “before” picture in memory. The block model duplicates the “before” data that had just been loaded in memory. Next, the block model applies the operations in the transaction to the new copy to create the “after” data. Then the model uses both “before” and “after” data to validate the changes for permissions and data coherency. If everything checks out, all created or changed records are committed to the database—meaning the block has now officially been created. At this point, a “success” HTTP response to the original API request is sent by the client. This confirms that the client knows the transaction was saved successfully and that it can move on to saving the next transaction in the TransactionQueue. In the background, the block model schedules additional work depending on the kind of change made for the transaction. For example, the block model can schedule version history snapshots and indexing block text for a Quick Find function. The block model also notifies MessageStore, which is a real-time updates service, about the changes that were made.

The block model provides real-time updates to, for example, almost instantaneously show new blocks to members of a teamspace. Every client can have a long-lived WebSocket connection to the MessageStore. When the client renders a block (or page, or any other kind of record), the client subscribes to changes of that record from MessageStore using the WebSocket connection. When a team member opens the same page, the member is subscribed to changes of all those blocks. After changes have been made through the saveTransactions process, the API notifies MessageStore of new recorded versions. MessageStore finds client connections subscribed to those changing records and passes on the new version through their WebSocket connection. When a team member’s client receives version update notifications from MessageStore, it verifies that version of the block in its local cache. Because the versions from the notification and the local block are different, the client sends a syncRecordValues API request to the server with the list of outdated client records. The server responds with the new record data. The client uses this response data to update the local cache with the new version of the records, then re-renders the user interface to display the latest block data.

Blocks can be shared instantaneously with collaborators. In one example, a page is loaded using only local data. On the web, block data is pulled from being in memory. On native apps, loading blocks that are not in memory are loaded from the RecordCache persisted storage. However, if missing block data is needed, the data is requested from an API. The API method for loading the data for a page is referred to herein as loadPageChunk; it descends from a starting point (likely the block ID of a page block) down the content tree and returns the blocks in the content tree plus any dependent records needed to properly render those blocks. Several layers of caching for loadPageChunk are used, but in the worst case, this API might need to make multiple trips to the database as it recursively crawls down the tree to find blocks and their record dependencies. All data loaded by loadPageChunk is put into memory (and saved in the RecordCache if using the app). Once the data is in memory, the page is laid out and rendered using React.

### Software Platform

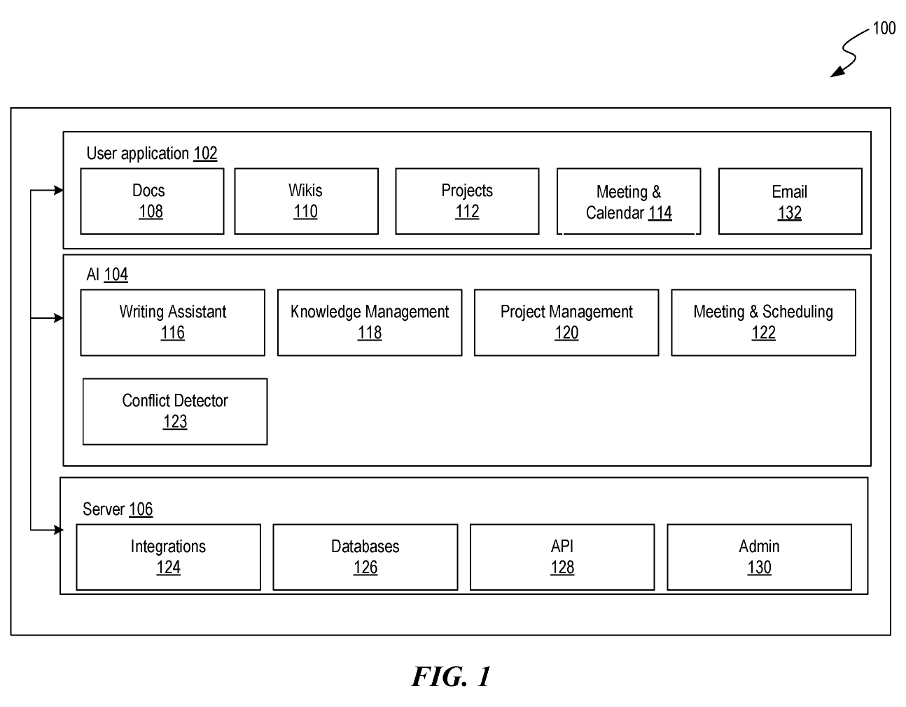

FIG. 1 is a block diagram of an example platform 100. The platform 100 provides users with an all-in-one workspace for data and project management. The platform 100 can include a user application 102, an AI tool 104, and a server 106. The user application 102, the AI tool 104, and the server 106 are in communication with each other via a network.

In some implementations, the user application 102 is a cross-platform software application configured to work on several computing platforms and web browsers. The user application 102 can include a variety of templates. A template refers to a prebuilt page that a user can add to a workspace within the user application 102. The templates can be directed to a variety of functions. Exemplary templates include a docs template 108, a wikis template 110, a projects template 112, a meeting and calendar template 114, and an email template 132. In some implementations, a user can generate, save, and share customized templates with other users.

The user application 102 templates can be based on content “blocks.” For example, the templates of the user application 102 include a predefined and/or pre-organized set of blocks that can be customized by the user. Blocks are content containers within a template that can include text, images, objects, tables, maps, emails, and/or other pages (e.g., nested pages or sub-pages). Blocks can be assigned to certain properties. The blocks are defined by boundaries having dimensions. The boundaries can be visible or non-visible for users. For example, a block can be assigned as a text block (e.g., a block including text content), a heading block (e.g., a block including a heading) or a sub-heading block having a specific location and style to assist in organizing a page. A block can be assigned as a list block to include content in a list format. A block can be assigned as an AI prompt block (also referred to as a “prompt block”) that enables a user to provide instructions (e.g., prompts) to the AI tool 104 to perform functions. A block can also be assigned to include audio, video, or image content.

A user can add, edit, and remove content from the blocks. The user can also organize the content within a page by moving the blocks around. In some implementations, the blocks are shared (e.g., by copying and pasting) between the different templates within a workspace. For example, a block embedded within multiple templates can be configured to show edits synchronously.

The docs template 108 is a document generation and organization tool that can be used for generating a variety of documents. For example, the docs template 108 can be used to generate pages that are easy to organize, navigate, and format. The wikis template 110 is a knowledge management application having features similar to the pages generated by the docs template 108 but that can additionally be used as a database. The wikis template 110 can include, for example, tags configured to categorize pages by topic and/or include an indication of whether the provided information is verified to indicate its accuracy and reliability. The projects template 112 is a project management and note-taking software tool. The projects template 112 can allow the users, either as individuals or as teams, to plan, manage, and execute projects in a single forum. The meeting and calendar template 114 is a tool for managing tasks and timelines. In addition to traditional calendar features, the meeting and calendar template 114 can include blocks for categorizing and prioritizing scheduled tasks, generating to-do and action item lists, tracking productivity, etc. The various templates of the user application 102 can be included under a single workspace and include synchronized blocks. For example, a user can update a project deadline on the projects template 112, which can be automatically synchronized to the meeting and calendar template 114. The various templates of the user application 102 can be shared within a team, allowing multiple users to modify and update the workspace concurrently.

The email template 132 allows the users to customize their inbox by representing the inbox as a customizable database where the user can add custom columns and create custom views with layouts. One view can include multiple layouts including a calendar layout, a summary layout, and urgent information layout. Each view can include a customized structure including custom criteria, custom properties, and custom actions. The custom properties can be specific to a view such as artificial intelligence-extracted properties, and/or heuristic-based properties. The custom actions can trigger automatically when a message enters the view. The custom actions can include deterministic rules like “Archive this," or assistant workflows like responding to support messages by searching user applications 102 or filing support tickets. In addition, the view can include actions, such as buttons, that are custom to the view and perform operations on the messages in the inbox. Only the customized structure can be shared with other users of the system, or both the customized structure and the messages can be shared.

The integration of the docs template 108, the wikis template 110, the projects template 112, the meeting and calendar template 114, and the email template 132 enables linking and embedding of templates within other templates. For example, an email sent from an email address within the platform 100 to another email address within the platform 100, can include an embedding of a document within the platform 100, or an embedding of a block in the document. In another example, a wiki can link to a meeting within the calendar.

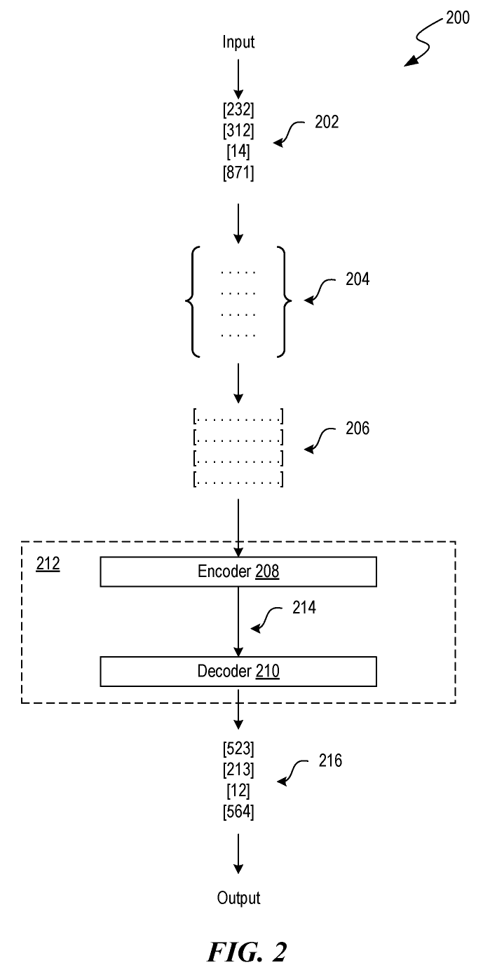

The AI tool 104 is an integrated AI assistant that enables AI-based functions for the user application 102. In one example, the AI tool 104 is based on a neural network architecture, such as the transformer 212 described in FIG. 2. The AI tool 104 can interact with blocks embedded within the templates on a workspace of the user application 102. For example, the AI tool 104 can include a writing assistant tool 116, a knowledge management tool 118, a project management tool 120, a meeting and scheduling tool 122, and/or a conflict detector 123. The different tools of the AI tool 104 can be interconnected and interact with different blocks and templates of the user application 102.

The writing assistant tool 116 can operate as a generative AI tool for creating content for the blocks in accordance with instructions received from a user. Creating the content can include, for example, summarizing, generating new text, or brainstorming ideas. For example, in response to a prompt received as a user input that instructs the AI to describe what the climate is like in New York, the writing assistant tool 116 can generate a block including a text that describes the climate in New York. As another example, in response to a prompt that requests ideas on how to name a pet, the writing assistant tool 116 can generate a block including a list of creative pet names. The writing assistant tool 116 can also operate to modify existing text. For example, the writing assistant can shorten, lengthen, or translate existing text, correct grammar and typographical errors, or modify the style of the text (e.g., a social media style versus a formal style).

The knowledge management tool 118 can use AI to categorize, organize, and share knowledge included in the workspace. In some implementations, the knowledge management tool 118 can operate as a question-and-answer assistant. For example, a user can provide instructions on a prompt block to ask a question. In response to receiving the question, the knowledge management tool 118 can provide an answer to the question, for example, based on information included in the wikis template 110. The project management tool 120 can provide AI support for the projects template 112. The AI support can include auto filling information based on changes within the workspace or automatically track project development. For example, the project management tool 120 can use AI for task automation, data analysis, real-time monitoring of project development, allocation of resources, and/or risk mitigation. The meeting and scheduling tool 122 can use AI to organize meeting notes, unify meeting records, list key information from meeting minutes, and/or connect meeting notes with deliverable deadlines.

The conflict detector 123 can perform content detection in collaborative content management. For example, the conflict detector 123 can access a particular target document, such as a block and/or a page, and generate a set of inferred questions using the target document. For example, a document about an upcoming product launch might answer questions such as "What is launching?" "When is [Product X] launching?" "Who is the target audience for [Product X]?" and so forth. The inferred questions can be utilized to search knowledge sources that are supplemental to the target document or independent from the target document. For example, the conflict detector 123 can search related pages, related blocks, discussion threads, third-party project plans, content created by other users, and so forth. The conflict detector 123 can compare the responses (in some implementations, summarized, consolidated, or otherwise pre-processed responses) to data points in the target document. If discrepancies are identified, the conflict detector 123 can generate automatic comments, text entries (e.g., text entries in a panel accessible to a particular user in connection with viewing the page), annotations, electronic messages, push notifications, or the like to flag the discrepancies to page owners, content creators, support teams, collaborator teams, and/or other entities. The conflict detector 123 can also generate proposed edits to the target document.

The server 106 can include various units (e.g., including compute and storage units) that enable the operations of the AI tool 104 and workspaces of the user application 102. The server 106 can include an integrations unit 124, an application programming interface (API) 128, databases 126, and an administration (admin) unit 130. The databases 126 are configured to store data associated with the blocks. The data associated with the blocks can include information about the content included in the blocks, the function associated with the blocks, and/or any other information related to the blocks. The API 128 can be configured to communicate the block data between the user application 102, the AI tool 104, and the databases 126. The API 128 can also be configured to communicate with remote server systems, such as AI systems. For example, when a user performs a transaction within a block of a template of the user application 102 (e.g., in a docs template 108), the API 128 processes the transaction and saves the changes associated with the transaction to the database 126. The integrations unit 124 is a tool connecting the platform 100 with external systems and software platforms. Such external systems and platforms can include other databases (e.g., cloud storage spaces), messaging software applications, or audio or video conference applications. The administration unit 130 is configured to manage and maintain the operations and tasks of the server 106. For example, the administration unit 130 can manage user accounts, data storage, security, performance monitoring, etc.

### Transformer for Neural Network

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN can encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others. Unlike discriminative models, generative models are distinguished by their ability to create new, synthetic data that closely resembles the training data. In contrast, discriminative models focus on predicting labels for given inputs.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a “language model”), the training dataset may be a collection of text documents, referred to as a “text corpus” (or simply referred to as a “corpus”). The corpus may represent a language domain (e.g., a single language), a subject domain (e.g., scientific papers), and/or may encompass another domain or domains, be they larger or smaller than a single language or subject domain. For example, a relatively large, multilingual, and non-subject-specific corpus can be created by extracting text from online webpages and/or publicly available social media posts. Training data can be annotated with ground truth labels (e.g., each data entry in the training dataset can be paired with a label) or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data can be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters can be determined based on the measured performance of one or more of the trained ML models, and the first step of training (e.g., with the training set) may begin again on a different ML model described by the new set of determined hyperparameters. In this way, these steps can be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model’s accuracy. Other segmentations of the larger data set and/or schemes for using the segments for training one or more ML models are possible.

Backpropagation is an algorithm for training an ML model. Backpropagation is used to adjust (e.g., update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (e.g., “learn”) the parameters to reduce the loss function. Backpropagation is performed iteratively so that the loss function is converged or minimized. Other techniques for learning the parameters of the ML model can be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters can then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publicly available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to an ML-based language model, there could exist non-ML language models. In the present disclosure, the term “language model” can refer to an ML-based language model (e.g., a language model that is implemented using a neural network or other ML architecture), unless stated otherwise. For example, unless stated otherwise, the “language model” encompasses LLMs (large language models).

A language model can use a neural network (typically a DNN) to perform natural language processing (NLP) tasks. A language model can be trained to model how words relate to each other in a textual sequence, based on probabilities. A language model may contain hundreds of thousands of learned parameters or, in the case of an LLM, can contain millions or billions of learned parameters or more. As non-limiting examples, a language model can generate text, translate text, summarize text, answer questions, write code (e.g., Python, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

A type of neural network architecture, referred to as a “transformer,” can be used for language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 2 is a block diagram of an example transformer 212. A transformer is a type of neural network architecture that uses self-attention mechanisms to generate predicted output based on input data that has some sequential meaning (e.g., the order of the input data is meaningful, which is the case for most text input). Self-attention is a mechanism that relates different positions of a single sequence to compute a representation of the same sequence. Although transformer-based language models are described herein, the present disclosure may be applicable to any ML-based language model, including language models based on other neural network architectures such as recurrent neural network (RNN)-based language models.

The transformer 212 includes an encoder 208 (which can include one or more encoder layers/blocks connected in series) and a decoder 210 (which can include one or more decoder layers/blocks connected in series). Generally, the encoder 208 and the decoder 210 each include multiple neural network layers, at least one of which can be a self-attention layer. The parameters of the neural network layers can be referred to as the parameters of the language model.

The transformer 212 can be trained to perform certain functions on a natural language input. Examples of the functions include summarizing existing content, brainstorming ideas, writing a rough draft, fixing spelling and grammar, and translating content. Summarizing can include extracting key points or themes from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user’s writing. The style can be identified as, e.g., an email, a blog post, a social media post, or a poem. Fixing spelling and grammar can include correcting errors in an existing input text. Translating can include converting an existing input text into a variety of different languages. In some implementations, the transformer 212 is trained to perform certain functions on other input formats than natural language input. For example, the input can include objects, images, audio content, or video content, or a combination thereof.

The transformer 212 can be trained on a text corpus that is labeled (e.g., annotated to indicate verbs, nouns) or unlabeled. LLMs can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input).

FIG. 2 illustrates an example of how the transformer 212 can process textual input data. Input to a language model (whether transformer-based or otherwise) typically is in the form of natural language that can be parsed into tokens. The term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some implementations, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 2, a short sequence of tokens 202 corresponding to the input text is illustrated as input to the transformer 212. Tokenization of the text sequence into the tokens 202 can be performed by some pre-processing tokenization module such as, for example, a byte-pair encoding tokenizer (the “pre” referring to the tokenization occurring prior to the processing of the tokenized input by the LLM), which is not shown in FIG. 2 for brevity. In general, the token sequence that is inputted to the transformer 212 can be of any length up to a maximum length defined based on the dimensions of the transformer 212. Each token 202 in the token sequence is converted into an embedding vector 206 (also referred to as “embedding 206”).

An embedding 206 is a learned numerical representation (such as, for example, a vector) of a token that captures some semantic meaning of the text segment represented by the token 202. The embedding 206 represents the text segment corresponding to the token 202 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 206 corresponding to the “write” token will be closer to another embedding corresponding to the “jot down” token in the vector space as compared to the distance between the embedding 206 corresponding to the “write” token and another embedding corresponding to the “summary” token.

The vector space can be defined by the dimensions and values of the embedding vectors. Various techniques can be used to convert a token 202 to an embedding 206. For example, another trained ML model can be used to convert the token 202 into an embedding 206. In particular, another trained ML model can be used to convert the token 202 into an embedding 206 in a way that encodes additional information into the embedding 206 (e.g., a trained ML model can encode positional information about the position of the token 202 in the text sequence into the embedding 206). In some implementations, the numerical value of the token 202 can be used to look up the corresponding embedding in an embedding matrix 204, which can be learned during training of the transformer 212.

The generated embeddings 206 are input into the encoder 208. The encoder 208 serves to encode the embeddings 206 into feature vectors 214 that represent the latent features of the embeddings 206. The encoder 208 can encode positional information (i.e., information about the sequence of the input) in the feature vectors 214. The feature vectors 214 can have very high dimensionality (e.g., on the order of thousands or tens of thousands), with each element in a feature vector 214 corresponding to a respective feature. The numerical weight of each element in a feature vector 214 represents the importance of the corresponding feature. The space of all possible feature vectors 214 that can be generated by the encoder 208 can be referred to as a latent space or feature space.

Conceptually, the decoder 210 is designed to map the features represented by the feature vectors 214 into meaningful output, which can depend on the task that was assigned to the transformer 212. For example, if the transformer 212 is used for a translation task, the decoder 210 can map the feature vectors 214 into text output in a target language different from the language of the original tokens 202. Generally, in a generative language model, the decoder 210 serves to decode the feature vectors 214 into a sequence of tokens. The decoder 210 can generate output tokens 216 one by one. Each output token 216 can be fed back as input to the decoder 210 in order to generate the next output token 216. By feeding back the generated output and applying self-attention, the decoder 210 can generate a sequence of output tokens 216 that has sequential meaning (e.g., the resulting output text sequence is understandable as a sentence and obeys grammatical rules). The decoder 210 can generate output tokens 216 until a special [EOT] token (indicating the end of the text) is generated. The resulting sequence of output tokens 216 can then be converted to a text sequence in post-processing. For example, each output token 216 can be an integer number that corresponds to a vocabulary index. By looking up the text segment using the vocabulary index, the text segment corresponding to each output token 216 can be retrieved, the text segments can be concatenated together, and the final output text sequence can be obtained.

In some implementations, the input provided to the transformer 212 includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text (e.g., adding bullet points or checkboxes). As an example, the input text can include meeting notes prepared by a user and the output can include a high-level summary of the meeting notes. In other examples, the input provided to the transformer includes a question or a request to generate text. The output can include a response to the question, text associated with the request, or a list of ideas associated with the request. For example, the input can include the question “What is the weather like in San Francisco?” and the output can include a description of the weather in San Francisco. As another example, the input can include a request to brainstorm names for a flower shop and the output can include a list of relevant names.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available online to the public. GPT-3 has a very large number of learned parameters (on the order of hundreds of billions), can accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ multiple processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via an API (e.g., the API 128 in FIG. 1). As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Hierarchical Organizational Blocks in a Workspace

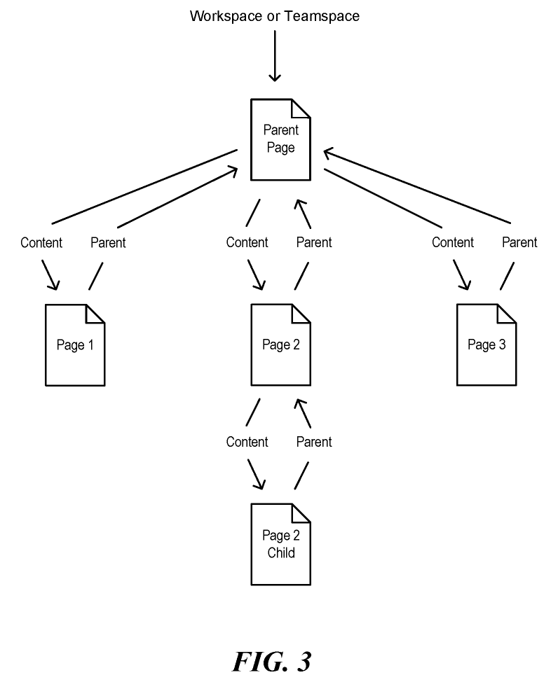

FIG. 3 is a block diagram illustrating a hierarchical organization of pages in a workspace. As described with respect to the block data model of the present technology, a workspace can include multiple pages (e.g., page blocks). The pages (e.g., including parent pages and child or nested pages) can be arranged hierarchically within the workspace or one or more teamspaces, as shown in FIG. 3. The page can include a block such as tabs, lists, images, tables, etc.

A teamspace can refer to a collaborative space associated with a team or an organization that is hierarchically below a workspace. For example, a workspace can include a teamspace accessible by all users of an organization and multiple teamspaces that are accessible by users of different teams. Accessibility generally refers to creating, editing, and/or viewing content (e.g., pages) included in the workspace or the one or more teamspaces.

In the hierarchical organization illustrated in FIG. 3, a parent page (e.g., “Parent Page”) is located hierarchically below the workspace or a teamspace. The parent page includes three children pages (e.g., “Page 1,” “Page 2,” and “Page 3”). Each of the child pages can further include subpages (e.g., “Page 2 Child” which is a grandchild of “Parent Page” and child of “Page 2”). The “Content” arrows in FIG. 3 indicate the relationship between the parents and children while the “Parent” arrows indicate the inheritance of access permissions. The child pages inherit access permission from the (immediate) parent page under which they are located hierarchically (e.g., which is above them in the tree). For example, “Page 2” inherited the access permission of the “Parent page” as a default when it was created under its parent page. Similarly, “Page 2 Child” inherited the access permission of the parent page as a default when it was created under its parent page. “Parent Page,” “Page 2,” and “Page 2 Child” thereby have the same access permission within the workspace.

The relationships and organization of the content can be modified by changing the location of the pages. For example, when a child page is moved to be under a different parent, the child page’s access permission modifies to correspond to the access permission of the new parent. Also, when the access permission of “Parent Page” is modified, the access permission of “Page 1,” “Page 2,” and “Page 3” can be automatically modified to correspond to the access permission of “Parent Page” based on the inheritance character of access permissions.

In contrast, however, a user can modify the access permission of the children independently of their parents. For example, the user can modify the access permission of “Page 2 Child” in FIG. 3 so that it is different from the access permission of “Page 2” and “Parent Page.” The access permission of “Page 2 Child” can be modified to be broader or narrower than the access permission of its parents. As an example, “Page 2 Child” can be shared on the internet while “Page 2” is only shared internally to the users associated with the workspace. As another example, “Page 2 Child” can be shared only with an individual user while “Page 2” is shared with a group of users (e.g., a team of the organization associated with the workspace). In some implementations, the hierarchical inheritance of the access permissions described herein can be modified from the previous description. For example, the access permissions of all the pages (parent and children) can be defined as independently changeable.

### AI-Driven Conflict Detection in Collaborative Project Management

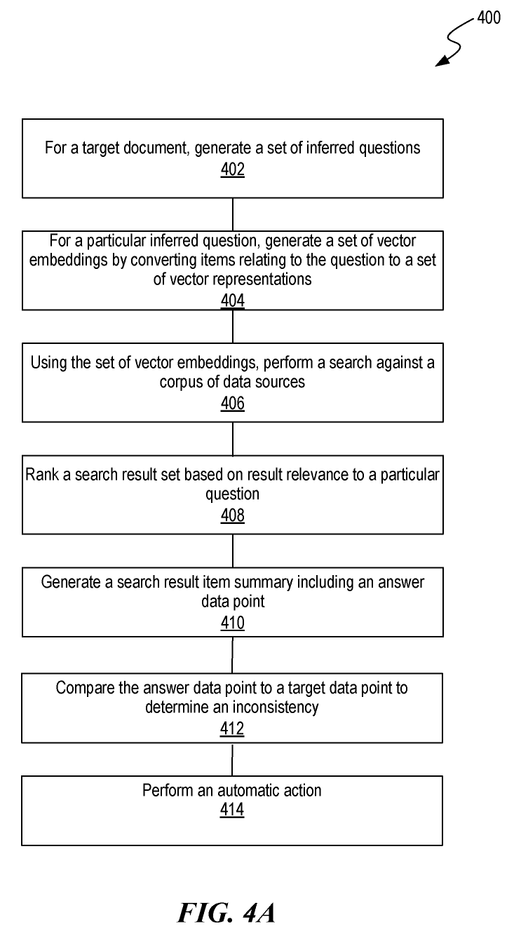

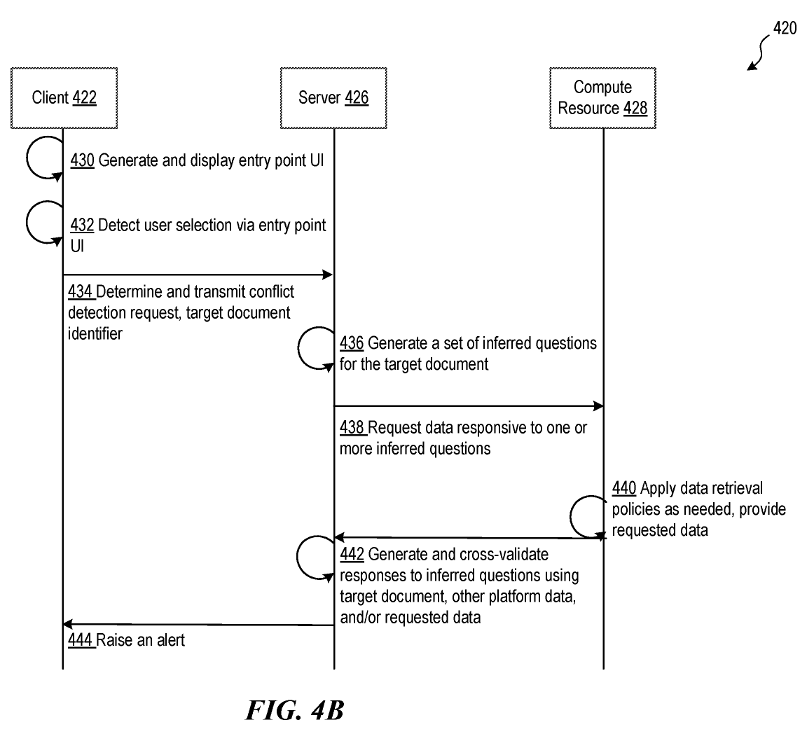

FIG. 4A is a block diagram illustrating an example process 400 for AI-driven conflict detection in collaborative content management. The operations described herein can be performed, in whole or in part, by the conflict detector 123 or by another suitable component. For example, to access various data stores, the conflict detector 123 can utilize integrations 124 (e.g., to access third-party systems, such as project management systems and/or communication platforms), databases 126, and/or APIs 128.

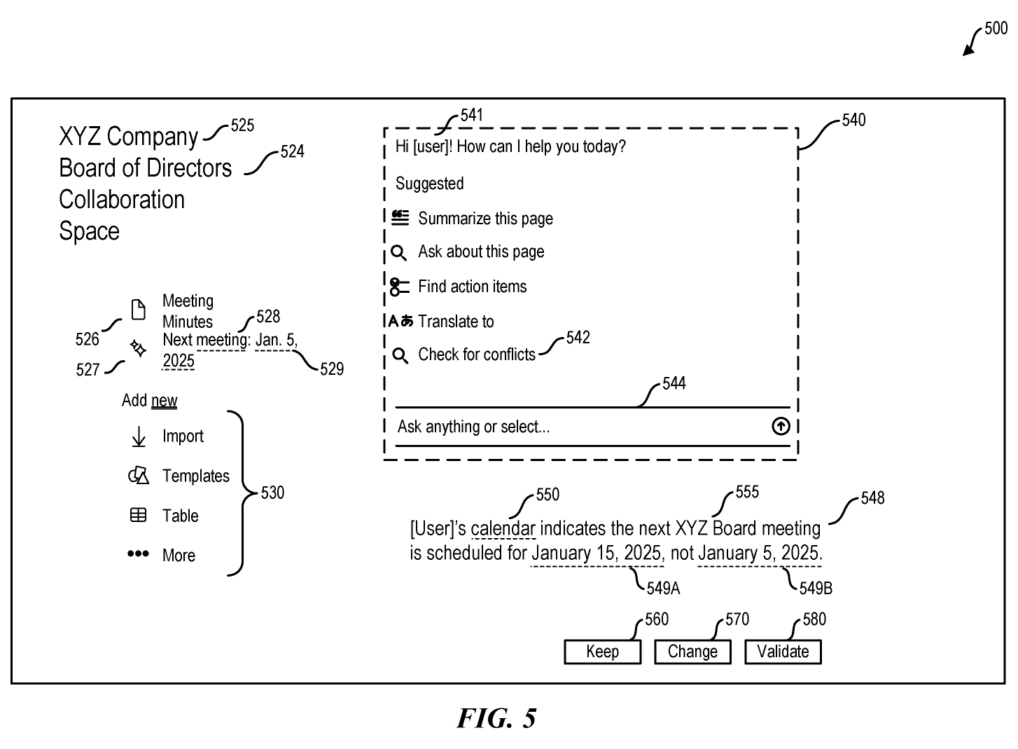

In some implementations, an entry point to the process 400 can include a menu accessible from the particular block or page, such as an example menu 540 of FIG. 5. In some implementations, process 400 can be executed automatically at a predetermined frequency, such as once a week, once a month, etc. In some implementations, the process 400 can include checking a particular block or page (e.g., checking metadata, attribute, and/or property of the block or page) to determine whether the block or page is eligible for verification. In some use cases, the block or page is eligible for verification if a particular entity (e.g., subscriber) has the corresponding feature enabled, as determined, for example, by referencing subscriber profile data. If the feature is enabled, the executables and/or user interfaces associated with the conflict detector 123 can be made available to be invoked by the subscriber. In some use cases, a particular block or page can have a verification status of "Verified" and/or "Expired Verification”, and the process 400 can be automatically triggered when it is determined that the status is “Expired Verification”. In some use cases, the particular block or page can be made accessible to a predetermined quantity of users or to a predetermined set of members of a particular workspace. In some use cases, the particular block or page can have at least certain predetermined permissions, such as "Everyone" or "Anyone with link", before the process 400 can be performed on the block or page. In some use cases, at least one verifier is verified to be a member of a particular workspace to which the page or block belongs, which can enable notifications to be sent to ensure timely action on the output of the conflict detector 123. By satisfying such example conditions or other suitable conditions (e.g., triggering the conflict detection process in real-time as user input is detected), conflict detector 123 can efficiently identify discrepancies and facilitate updates to maintain data integrity in a particular page or block.

Process 400 can include determining, at 402, the author's intent by utilizing a neural network (e.g., a transformer neural network, such as that of FIG. 2) to infer questions addressed by a particular block or page, also sometimes referred to as target document. At 404, process 400 can include generating a set of vector embeddings for a particular inferred question. At 406, process 400 can include using the set of vector embeddings to perform a search against a corpus of data sources, which can include other pages and/or blocks accessible to a particular user or subscriber, local documents associated with the user, cloud storage services, and/or third-party communication platforms. The corpus of data sources to search can be determined, for example, by identifying information that relates to similar topics relative to content of the page and/or block. The data sources can be identified using various suitable techniques, such as deterministic rules, titles, metadata, tags, linked data, permission sets, and so forth. In some implementations, an initial set of data sources can be pre-processed to determine whether a particular candidate knowledge source is relevant. Pre-processing can be performed utilizing summarization, natural language processing techniques, keyword searches, semantic searches, or other suitable techniques.

At 408, process 400 can include ranking/re-ranking search results based on relevance to the inferred questions and/or other contextual information, such as user information, page or block tags, page or block metadata, page or block recency, and/or page or block order in a set of similar items (e.g., when a page or block is included in a series of sequential project updates, meeting minutes, and so forth). At 410, process 400 can include summarizing answer data points, which can be done, for example, using a transformer model, such as the model of FIG. 2. In some implementations, top N (e.g., top 1, top 3, top 5, top 10) ranked search results are summarized. At 412, process 400 can include comparing the summarized answers with content items of the original block or page, which can be done, for example, using a transformer model, such as the model of FIG. 2.

Upon identifying inconsistencies between the summarized answers and the original block and/or page, at 414, the platform can generate a set of proposed edits for presentation to a user and/or perform another automatic action. In some implementations, the platform can generate alerts and/or notifications. In some implementations, the platform can visually emphasize the relevant content. In some implementations, the platform can tag the relevant content and/or associate an accuracy score with the relevant content. The flags and/or accuracy scores can be made available to downstream processes, such as downstream automatic and/or artificial intelligence operations that utilize the content.

FIG. 4B is a block diagram illustrating an example flow 420 of electronic messages for automated, AI-driven conflict detection in collaborative content management. In an example arrangement, one or more of each of a client 422, server 426, and compute resource 428 are communicatively connected and enabled to exchange electronic messages. Client 422 can include at least a portion of the user application 102 and/or AI tool 104 described in connection with FIG. 1, or another suitable module. Server 426 can include at least a portion of the user application 102, AI tool 104 and/or server 106, or another suitable module. Compute resource 428 can be a local or remote compute resource, such as a memory, database, application, exposed API, gateway, web server, computing system or another addressable module or system.

In some implementations, the compute resource 428 is a resource included in or associated with the platform 100 (e.g., email platform, project repository, calendar, and so forth). In some implementations, the compute resource 428 is a third-party resource, such as a resource accessible via an integration 124, API 128, or in another manner. An example compute resource 428 can include one or more of a shared drive, a file repository, a chat platform, a project management platform, an email platform, a calendar or scheduling platform, a customer relationship management (CRM) platform, a customer service platform, a business intelligence (BI) platform, a human resources (HR) management platform, a design platform, an image or video generation platform, and so forth. In some use cases, the compute resource 428 includes, at least in part the server 426 (e.g., the compute resource 428 is a platform rather than a third-party compute resource).

In various use cases, the conflict detector 123 can detect conflicts or variances between a particular alphanumeric or image-based item stored in a particular block (e.g., a block accessible via a block identifier) and a corresponding item from the compute resource. The corresponding item can include alphanumeric data, special character data, images, videos, audio, tabular data, key-value pairs, query result sets, sets of embeddings (vectorized data), or any other suitable data. The corresponding item can be cross-referenced to validate text, dates, timestamps, calculations, numeric values, images, tabular values, metadata, data schemas, and so forth. Example items suitable for validation can include scheduling information, meeting attendee information, lists of deliverables, project tasks, due dates, project artifacts, factual information, code sets, information pertaining to individuals (e.g., names, account handles, account information), photographic information, checksum information, version information, hash values, pixel data, audio sample data, image metadata (e.g., EXIF), audio file metadata (e.g., ID3), schema definitions (e.g., XML structures, JSON structures, file directory definitions), hyperlinks or portions thereof, and the like.

As shown, at 430, the client 422 can generate and display an entry point user interface, such as menu 540 of FIG. 5. At 432, the client 422 can detect a user selection (a conflict check entry point 542), user provisioning of a particular command (e.g., a natural-language command 544), and/or user entry of certain inputs (e.g., character sequences, clicks in the natural-language command field) that causes the client 422, at 434, to determine and transmit a conflict detection request to the server 426. More broadly, the conflict check entry point 542 can encompass any of the aforementioned items. In some implementations, the conflict detection request can include a block identifier, which can be automatically determined using contextual or session information. In some implementations, the conflict detection request can include a set of items associated with the block identifier (e.g., a set of more than one item to be validated). In some implementations, the items can be selected or skipped based on metadata (e.g., particular items can be skipped if they are marked as validated within a predetermined time range (e.g., 1 day, 1 week), by a particular user, and/or marked as sensitive items (e.g., personal health information, personally identifiable information, confidential information)). In some implementations, specific items to validate are determined using the natural-language command 544. For example, if the user asks “when was the last team meeting? please cross-check”, the platform can apply an intent analysis technique and select a particular item in a block (“meeting date”).

At 436, the server 426 can generate a set of questions (e.g., inferred questions, queries, and so forth) using block and/or document identifier(s) received from the client 422 or determined at the server 426 (e.g., determined using a block identifier received from the client). To generate a set of questions that validate specific content items, the conflict detector 123 can employ text analysis, entity recognition, and other suitable techniques. In an example, the process of generating a particular set of questions can begin with text analysis, where certain elements such as entities, concepts, keywords, and/or sentence structures are identified using content stored in a particular block. Named Entity Recognition (NER) or another suitable technique can be used to identify and categorize entities in the text, including names, locations, and organizations. For example, in the sentence "John Smith, a software engineer at ABC Corporation, developed a new AI-powered chatbot," the entities recognized using NER can be "John Smith" as a person, "ABC Corporation" as an organization, and "AI-powered chatbot" as a concept. Part-of-Speech (POS) tagging can be utilized by the conflict detector 123 to identify the parts of speech for each word, and dependency parsing can be utilized to analyze the grammatical structure to identify relationships between words and phrases.

The analyzed data can be used to generate questions that validate specific items in the text. In some implementations, this can be achieved through template-based question generation, where pre-defined templates with slots for entities, concepts, and keywords are used. In some implementations, neural network-based question generation techniques can be employed, where a neural network (e.g., a transformer described in connection with FIG. 2) is trained to generate questions based on patterns in the text. For instance, given the content "In May 2025, John Smith, a software engineer at ABC Corporation, developed a new AI-powered chatbot. The chatbot, named 'Echo,' uses machine learning algorithms to provide personalized customer support,” the conflict detector 123 can generate the following list of questions: “Who developed the AI-powered chatbot?” “What is the name of the chatbot developed by John Smith?” “Which company does John Smith work for?” “What technology does the Echo chatbot utilize?” “What is the primary function of the Echo chatbot?” “When did John Smith develop the AI-powered chatbot?”

In some implementations, at 436, the set of generated questions can be filtered and/or ranked based on relevance to the input text, clarity, concision, and uniqueness. This can ensure that the resulting questions are accurate, easy to understand, and relevant to the original text. In some implementations, the generated questions can undergo post-processing, including grammar and spell checking, conversion to a query language, and so forth.

In some implementations, the conflict detector 123 can identify a particular compute resource 428 from a set of compute resources using items parsed from the content and/or from the generated questions. For example, the conflict detector 123 can use portions of content (“company”, “John Smith”, “chatbot”) to identify a first compute resource 428 that hosts project management data, such as project descriptions, implementation tasks, and go-live dates. The conflict detector 123 can also use an item parsed from a particular generated question (“when”) to identify a responsive second compute resource 428 (e.g., an Outlook calendar, product ideation notes from a file repository, and so forth).

At 438, the server 426 can generate and cause transmission of a data request to one or more compute resources 428. At 440, a compute resource can retrieve and provide the requested data.

At 442, the server 426 can cross-validate the data by, for example, comparing the data to items parsed from the block content, associated with the block content, or approximating the block content.

Various suitable techniques can be used to cross-validate block data. In content-based comparison, Longest Common Subsequence (LCS) can identify the longest common sequence between two content items, Levenshtein distance can measure the minimum number of operations (insertions, deletions, substitutions) needed to transform one content item into another, and Jaro-Winkler distance can measure similarity between two items based on character matching and transpositions. Semantic similarity techniques can also be used by comparing a set of embeddings that encodes the block data to a set of embeddings that encodes the received data. Other techniques that compare derivatives of content can include binary comparisons (comparing items byte-by-byte), hash-based comparisons, and so forth. Comparisons based on schema data can include comparing definitions or data structures that host the content (e.g., table definitions, XML schemas, JSON schemas). Sampling-based comparisons can include generating pixel or sample sets using stored image or audio data and compare these sets to sample sets generated using the received data. Metadata-based comparisons can include comparing files based on file metadata, such as titles, timestamps, user information, and so forth. In some implementations, two or more comparison techniques are applied to optimize the process, conserve computing resources, and discard unlikely matches. For example, hash- or metadata-based comparisons can be performed before more computationally intensive content-based comparisons are performed.

In some implementations, the results can be ranked by assessing semantic similarity between block content and the requested data, using source credibility scoring, by generating confidence intervals, and so forth. In some implementations, a composite score (e.g., responsiveness score) can be generated deterministic logic, such as by using a suitable formula, for instance: Responsiveness Score = (0.3 × Relevance) + (0.2 × Accuracy) + (0.2 × Completeness) + (0.1 × Timeliness) + (0.1 × Engagement) + (0.1 × Confidence). In some implementations, the results can be classified using a trained large language model or another suitable system.

Intent matching (e.g., using an intent detection model to match the block or content creator’s likely intent to the result content received from the compute resource 428), can also be utilized by the conflict detector 123, enabling the platform to accurately identify and respond to user intentions. In an example, intent matching models can leverage ML and NLP techniques. Supervised learning models, such as Support Vector Machines and Random Forests, can be trained on labeled datasets. Deep learning models, including Convolutional Neural Networks and Recurrent Neural Networks, are also instrumental in intent matching. Additionally, pre-trained language models such as BERT, RoBERTa, and XLNet can be fine-tuned for intent detection. Hybrid models that combine machine learning and rule-based approaches can further improve accuracy. Subprocesses in intent matching operations can include text preprocessing, feature extraction, and contextual understanding. For instance, in some implementations, by considering conversation history, history of block edits, user preferences, user/creator organizational roles, linked block information, and so forth intent matching can enable the conflict detector 123 to provide personalized and relevant responses.

At 444, the conflict detector 123 can raise a displayable and/or audible alert to inform the user of the detected inconsistency, provide data and/or metadata edit recommendations, and enable users to keep the content as is, change the content, and/or invoke further validation operations (e.g., operations using different compute resources 428, different result set ranking methods, and the like).

FIG. 5 shows an example entry point 542 in a GUI 500 for automated, AI-driven conflict detection in collaborative content management. As shown, GUI 500 can enable user 541 to access an example page 524. The title of the page 524 (which can, in some implementations, be utilized as a block identifier, although block identifiers can be any suitable elements, whether exposed to the end user or not) can include a context identifier 525, which can be used for intent analysis when generating questions. The page 524 can include a set of linked blocks, such as meeting minutes 526 (which can contain a hyperlink to a platform or third-party resource, such as a collection of linked blocks or a file storage drive) and next meeting target date 527. The next meeting target date 527 can include a particular content item 529. The page can include additional menus (530, 540) that enable users to create, modify, delete, and/or interact with content. As shown, the menu 540 can include a conflict check entry point 542 and/or a natural-language command 544, which can be utilized to invoke the conflict check process.

In some implementations, the conflict check process can include intent analysis operations, which can be performed using context identifier 525 and/or other suitable items to determine a compute resource (e.g., meeting notes, agendas, task information, scheduling platform, such as calendar 550) that is likely a suitable cross-validation compute resource to determine whether the next meeting target date 527 for XYZ Board 555 is accurate. If an inaccuracy is detected (e.g., upon determining that the particular content item 529, which is a date 549B stored in the displayed block, is different from the date 549A retrieved from the calendar 550) the GUI can display an alert 548. In various implementations, the alert can include or be displayed in connection with GUI functions that enable automatic or user action, such as keep 560, change 570, and/or validate 580.

### Examples

In some aspects, the techniques described herein relate systems, methods, and/or one or more non-transitory, computer-readable storage media including instructions recorded thereon, wherein the instructions, when executed by at least one data processor of a computing system, cause the computing system to: generate and display a graphical user interface (GUI) including a target block identifier in a block-based structure and a conflict check entry point; responsive to detecting a user interaction, via the GUI, with the conflict check entry point, perform operations including: using the target block identifier, generate a set of questions, wherein a particular question in the set of questions relates to a particular content item associated with the target block identifier; for a particular question in the set of questions, determine a cross-validation compute resource and generate a data retrieval call to the cross-validation compute resource; receive a cross-validation data item from the cross-validation compute resource; using the cross-validation data item, generate (1) an electronic command relating to the content item and (2) metadata relating to the particular content item; using the target block identifier, cause execution of the electronic command to perform two or more of: (i) raising an alert relating to the particular content item, (ii) modifying the particular content item, or (iii) performing additional cross-validation operations in connection with the particular content item.

In some aspects, the techniques described herein relate to a media, wherein the instructions to generate the set of questions, when executed by the at least one data processor of the computing system, cause the computing system to: perform a set of intent analysis operations on at least a portion of the particular content item and one or more of a history of block edits determined using the target block identifier, user question history and user-related information.

In some aspects, the techniques described herein relate to a media, wherein the particular question is a first question, the data retrieval call is a first data retrieval call, the cross-validation compute resource is a first cross-validation compute resource, and the cross-validation data item is a first cross-validation data item, and wherein the instructions, when executed by the at least one data processor of the computing system, cause the computing system to: for a second question in the set of questions, determine a second cross-validation compute resource and generate a second data retrieval call to the second cross-validation compute resource; receive a second cross-validation data item from the second cross-validation compute resource; using the first cross-validation data item and a second cross-validation data item, generate a cross-validation data set including a set of ranked items; select, from the cross-validation data set, a set of answer data points having at least a predetermined ranking; and using the selected set of answer data points, determine a responsive cross-validation data item.

In some aspects, the techniques described herein relate to a media, wherein the instructions, when executed by the at least one data processor of the computing system, cause the computing system to: update the metadata relating to the particular content item.

In some aspects, the techniques described herein relate to a media, wherein the metadata relating to the particular content item is utilized to select or skip the particular content item in response to detecting the user interaction with the conflict check entry point.

In some aspects, the techniques described herein relate to a media, wherein the instructions to generate the set of questions, when executed by the at least one data processor of the computing system, cause the computing system to: using (1) the cross-validation data item and (2) at least one of: first supplemental information accessible using the target block identifier and second supplemental information accessible via the cross-validation compute resource, generate a summary including the cross-validation data item.

In some aspects, the techniques described herein relate to a media, wherein the instructions to generate the set of questions, when executed by the at least one data processor of the computing system, cause the computing system to: cause the GUI to display at least a portion of the summary in connection with the alert.

### Example Computer Systems

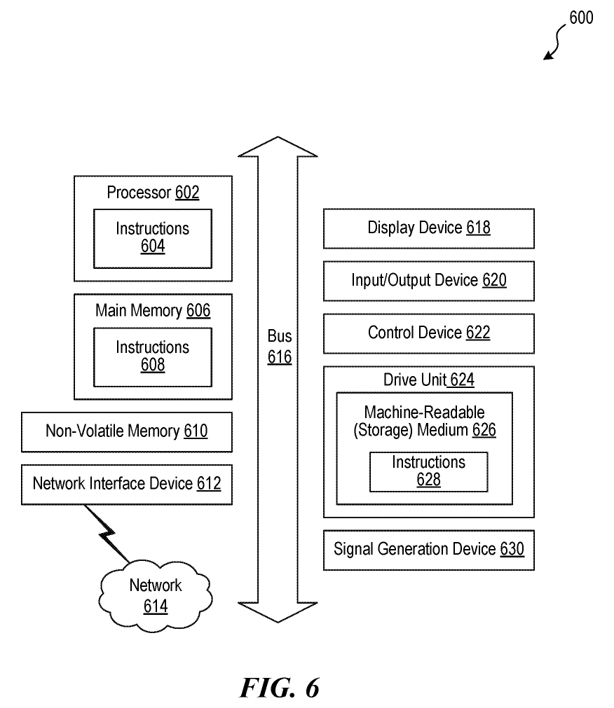

FIG. 6 is a block diagram that illustrates an example of a computer system 600 in which at least some operations described herein can be implemented. As shown, the computer system 600 can include: one or more processors 602, main memory 606, non-volatile memory 610, a network interface device 612, a display device 618, an input/output device 620, a control device 622 (e.g., keyboard and pointing device), a drive unit 624 that includes a machine readable (storage) medium 626, and a signal generation device 630 that are communicatively connected to a bus 616. The bus 616 represents one or more physical buses and/or point-to-point connections that are connected by appropriate bridges, adapters, or controllers. Various common components (e.g., cache memory) are omitted from FIG. 6 for brevity. Instead, the computer system 600 is intended to illustrate a hardware device on which components illustrated or described relative to the examples of the figures and any other components described in this specification can be implemented.

The computer system 600 can take any suitable physical form. For example, the computer system 600 can share a similar architecture as that of a server computer, personal computer (PC), tablet computer, mobile telephone, wearable electronic device, network-connected (“smart”) device (e.g., a television or home assistant device), AR/VR system (e.g., head-mounted display), or any electronic device capable of executing a set of instructions that specify action(s) to be taken by the computer system 600. In some implementations, the computer system 600 can be an embedded computer system, a system-on-chip (SOC), a single-board computer (SBC) system, or a distributed system such as a mesh of computer systems or include one or more cloud components in one or more networks. Where appropriate, one or more computer systems 600 can perform operations in real time, near real time, or in batch mode.

The network interface device 612 enables the computer system 600 to mediate data in a network 614 with an entity that is external to the computer system 600 through any communication protocol supported by the computer system 600 and the external entity. Examples of the network interface device 612 include a network adapter card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 606, non-volatile memory 610, machine-readable medium 626) can be local, remote, or distributed. Although shown as a single medium, the machine-readable medium 626 can include multiple media (e.g., a centralized/distributed database and/or associated caches and servers) that store one or more sets of instructions 628. The machine-readable medium 626 can include any medium that is capable of storing, encoding, or carrying a set of instructions for execution by the computer system 600. The machine-readable medium 626 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 610, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 604, 608, 628) set at various times in various memory and storage devices in computing device(s). When read and executed by the processor 602, the instruction(s) cause the computer system 600 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the Detailed Description above using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the Detailed Description above explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

We claim:

1. One or more non-transitory, computer-readable storage media comprising instructions recorded thereon, wherein the instructions, when executed by at least one data processor of a computing system, cause the computing system to:
generate and display a graphical user interface (GUI) that includes a target block identifier in a block-based structure and a conflict check entry point;
responsive to detecting a user interaction, via the GUI, with the conflict check entry point, perform operations comprising:
using the target block identifier, generate a set of questions, wherein a particular question in the set of questions relates to a particular content item accessible using the target block identifier;
for a particular question in the set of questions, determine a cross-validation compute resource and generate a data retrieval call to the cross-validation compute resource;
receive a cross-validation data item from the cross-validation compute resource;
using the cross-validation data item, generate (1) an electronic command relating to the particular content item and (2) metadata relating to the particular content item;
using the target block identifier, cause execution of the electronic command to perform two or more of: (i) raising an alert relating to the particular content item, (ii) modifying the particular content item, or (iii) performing additional cross-validation operations to cross-check the particular content item.

2. The media of claim 1, wherein the instructions to generate the set of questions, when executed by the at least one data processor of the computing system, cause the computing system to:
using one or more of a history of block edits for the target block identifier, user question history, page view history, or user-related information, perform a set of intent analysis operations for a block identified by the target block identifier.

3. The media of claim 1, wherein the particular question is a first question, the data retrieval call is a first data retrieval call, the cross-validation compute resource is a first cross-validation compute resource, and the cross-validation data item is a first cross-validation data item, and wherein the instructions, when executed by the at least one data processor of the computing system, cause the computing system to:
for a second question in the set of questions, determine a second cross-validation compute resource and generate a second data retrieval call to the second cross-validation compute resource;
receive a second cross-validation data item from the second cross-validation compute resource;
using the first cross-validation data item and a second cross-validation data item, generate a cross-validation data set comprising a set of ranked items;
select, from the cross-validation data set, a set of answer data points having at least a predetermined ranking; and
using the selected set of answer data points, identify a responsive cross-validation data item.

4. The media of claim 1, wherein the instructions to generate the set of questions, when executed by the at least one data processor of the computing system, cause the computing system to:
using (1) the cross-validation data item and (2) at least one of: first supplemental information accessible using the target block identifier and second supplemental information accessible via the cross-validation compute resource, generate a summary comprising the cross-validation data item.

5. The media of claim 4, wherein the instructions to generate the set of questions, when executed by the at least one data processor of the computing system, cause the computing system to:
cause the GUI to display at least a portion of the summary in connection with the alert.

6. The media of claim 1, wherein the instructions, when executed by the at least one data processor of the computing system, cause the computing system to:
update the metadata relating to the particular content item.

7. The media of claim 1, wherein the metadata relating to the particular content item is utilized to select or skip the particular content item in response to detecting the user interaction with the conflict check entry point.

8. A computing system comprising at least one data processor and one or more non-transitory, computer-readable storage media having instructions recorded thereon, wherein the instructions, when executed by the at least one data processor of a computing system, cause the computing system to:
generate and display a graphical user interface (GUI) that includes a target block identifier in a block-based structure and a conflict check entry point;
responsive to detecting a user interaction, via the GUI, with the conflict check entry point, perform operations comprising:
using the target block identifier, generate a set of questions, wherein a particular question in the set of questions relates to a particular content item accessible using the target block identifier;
for a particular question in the set of questions, determine a cross-validation compute resource and generate a data retrieval call to the cross-validation compute resource;
receive a cross-validation data item from the cross-validation compute resource;
using the cross-validation data item, generate (1) an electronic command relating to the particular content item and (2) metadata relating to the particular content item;
using the target block identifier, cause execution of the electronic command to perform two or more of: (i) raising an alert relating to the particular content item, (ii) modifying the particular content item, or (iii) performing additional cross-validation operations to cross-check the particular content item.

9. The computing system of claim 8, wherein the instructions to generate the set of questions, when executed by the at least one data processor of the computing system, cause the computing system to:
using one or more of a history of block edits for the target block identifier, user question history, page view history, or user-related information, perform a set of intent analysis operations for a block identified by the target block identifier.

10. The computing system of claim 8, wherein the particular question is a first question, the data retrieval call is a first data retrieval call, the cross-validation compute resource is a first cross-validation compute resource, and the cross-validation data item is a first cross-validation data item, and wherein the instructions, when executed by the at least one data processor of the computing system, cause the computing system to:
for a second question in the set of questions, determine a second cross-validation compute resource and generate a second data retrieval call to the second cross-validation compute resource;
receive a second cross-validation data item from the second cross-validation compute resource;
using the first cross-validation data item and a second cross-validation data item, generate a cross-validation data set comprising a set of ranked items;
select, from the cross-validation data set, a set of answer data points having at least a predetermined ranking; and
using the selected set of answer data points, identify a responsive cross-validation data item.

11. The computing system of claim 8, wherein the instructions to generate the set of questions, when executed by the at least one data processor of the computing system, cause the computing system to:
using (1) the cross-validation data item and (2) at least one of: first supplemental information accessible using the target block identifier and second supplemental information accessible via the cross-validation compute resource, generate a summary comprising the cross-validation data item.

12. The computing system of claim 11, wherein the instructions to generate the set of questions, when executed by the at least one data processor of the computing system, cause the computing system to:
cause the GUI to display at least a portion of the summary in connection with the alert.

13. The computing system of claim 8, wherein the metadata relating to the particular content item is utilized to select or skip the particular content item in response to detecting the user interaction with the conflict check entry point.

14. A method, comprising:
generating and displaying a graphical user interface (GUI) that includes a target block identifier in a block-based structure and a conflict check entry point;
responsive to detecting a user interaction, via the GUI, with the conflict check entry point, performing operations comprising:
using the target block identifier, generating a set of questions, wherein a particular question in the set of questions relates to a particular content item accessible using the target block identifier;
for a particular question in the set of questions, determining a cross-validation compute resource and generate a data retrieval call to the cross-validation compute resource;
receiving a cross-validation data item from the cross-validation compute resource;
using the cross-validation data item, generating (1) an electronic command relating to the particular content item and (2) metadata relating to the particular content item;
using the target block identifier, causing execution of the electronic command to perform two or more of: (i) raising an alert relating to the particular content item, (ii) modifying the particular content item, or (iii) performing additional cross-validation operations to cross-check the particular content item.

15. The method of claim 14, further comprising:
using one or more of a history of block edits for the target block identifier, user question history, page view history, or user-related information, performing a set of intent analysis operations for a block identified by the target block identifier.

16. The method of claim 14, wherein the particular question is a first question, the data retrieval call is a first data retrieval call, the cross-validation compute resource is a first cross-validation compute resource, and the cross-validation data item is a first cross-validation data item, the method further comprising:
for a second question in the set of questions, determining a second cross-validation compute resource and generating a second data retrieval call to the second cross-validation compute resource;
receiving a second cross-validation data item from the second cross-validation compute resource;
using the first cross-validation data item and a second cross-validation data item, generating a cross-validation data set comprising a set of ranked items;
selecting, from the cross-validation data set, a set of answer data points having at least a predetermined ranking; and
using the selected set of answer data points, identifying a responsive cross-validation data item.

17. The method of claim 14, further comprising:
using (1) the cross-validation data item and (2) at least one of: first supplemental information accessible using the target block identifier and second supplemental information accessible via the cross-validation compute resource, generating a summary comprising the cross-validation data item.

18. The method of claim 17, further comprising:
cause the GUI to display at least a portion of the summary in connection with the alert.

19. The method of claim 14, further comprising updating the metadata relating to the particular content item.

20. The method of claim 14, wherein the metadata relating to the particular content item is utilized to select or skip the particular content item in response to detecting the user interaction with the conflict check entry point.
